(19) United States
(12) Patent Application Publication
(10) Pub. No.: US 2019/0205931 A1
(43) Pub. Date: Jul. 4, 2019

(54) CONTENT-CENTRIC DIGITAL ACQUISITION SYSTEMS AND METHODS

(71) Applicant: Judy Shapiro, New York, NY (US)

(72) Inventor: Judy Shapiro, New York, NY (US)

(21) Appl. No.: 16/238,817

(22) Filed: Jan. 3, 2019

Related U.S. Application Data
(60) Provisional application No. 62/613,211, filed on Jan. 3, 2018.

(51) Int. Cl. G06Q 30/02; G06F 16/9535; G06F 17/50

(52) U.S. Cl. CPC G06Q 30/0254; G06F 17/5009; G06F 16/9535

(57) ABSTRACT

A method for a content marketing includes identifying a plurality of topics found in content data based on a campaign, selecting relevant topics from the plurality of topics, which are relevant to the campaign, contextually matching contents of a plurality of publishers to the relevant topics, collecting customer data from the plurality of publishers, after a job is placed in the contextually-matched content of the plurality of publishers, and generating a predictive model for a conversion journey based on the customer data and the content data.

### CROSS-REFERENCE TO RELATED APPLICATIONS

This application claims priority to U.S. Provisional Application Ser. No. 62/613,211 filed Jan. 3, 2018, the entire contents of which are hereby incorporated herein by reference.

### BACKGROUND OF THE INVENTION

### 1. Technical Field

The present disclosure generally relates to systems and methods for a content marketing. More particularly, the present disclosure relates to content-centric digital acquisition systems and methods for scalable and quality reach of authenticated, topic-engaged audiences, real-time, semantic processing of web content for contextual topic-based advertisement placement, and a campaign platform that integrates data, buying, and a predictive model.

### 2. Background of Related Art

The fastest growing segments in the marketing field include the content marketing, the direct marketing, and the digital media marketing. The content marketing recommends or creates content for advertisers or publishers. The direct marketing performs automation and acquisition. The digital media marketing focuses on programmatic advertisement buying platforms, retargeting, and native advertising. However, these marketing methods are not sophisticated, integrated, scalable enough to meet the needs of the clients.

For example, the direct marketing is not targeting a group of people who have potential buying interest but distributing marketing materials to unidentified group of people. Thus, even if the direct marketing is scalable, such scale is not relevant to actual interest of people.

The digital media marketing focuses on clicking of links by people. For example, in pay-per-click (PPC) marketing, more clicks might show interest of more people. However, anonymous people's interest may not draw to purchases of products. Further, it is not certain that real people have clicked the links because automatic robots can imitate clicking. Thus, digital media marketing cannot meet advertisers' needs for verification. Further, scalability by the digital media marketing dose not assure more conversion to purchase of products but at the same time increases costs based on a pay-per-view scheme.

For another example, retargeting, also known as behavioral remarketing, targets consumers based on their previous internet actions. However, based on the context of this marketing, retargeting cannot bring new potential consumers, who are not from the group of previous consumers.

In yet another example, social media marketing can expose advertisements to many anonymous users. However, such exposures are not based on real interests of the users. Thus, return of monetization is substantially low compared to the PPC marketing or retargeting, while the number of exposures is comparatively more than the PPC marketing or retargeting.

In order to find a midpoint between the social marketing and the PPC or the retargeting, the content marketing is growing in the advertisement industries but has rooms for improvement. For example, contents selected by the content marketing might not be up to date and, as a result, do not yield expected conversions. Therefore, there are needs for real-time, content-centric, scalable, and quality marketing systems to meet clients' needs.

### SUMMARY OF THE INVENTION

The present disclosure relates to systems, apparatuses, and methods for controlling a content-centric digital acquisition system. As will be described herein in more detail, the content-centric digital acquisition system generates a predictive model for identifying good content journeys for prospective customers.

In an embodiment, a method for a content marketing includes identifying a plurality of topics found in content data based on a campaign, selecting relevant topics from the plurality of topics, which are relevant to the campaign, contextually matching contents of a plurality of publishers to the relevant topics, collecting customer data from the plurality of publishers, after a job is placed in the contextually-matched content of the plurality of publishers, and generating a predictive model for a conversion journey based on the customer data and the content data.

In an aspect, the predictive model reflects a customer's content journey to conversion. The most relevant topics are trending topics.

In another aspect, the content data includes first customer data from an external source and second content data from a client.

In still another aspect, the first customer data has been aggregated from websites via cookies or javascripts.

In still another aspect, the topics are identified from the second content data. The content data further includes third customer data for potential customers.

In still another aspect, identifying the plurality of topics includes clustering the first customer data to obtain a plurality of lookalikes, and identifying the plurality of topics based on a level of success in the plurality of lookalikes. The job is related to the identified topics. The plurality of publishers are contextually matched to the identified topics in real time. Identifying the plurality of topics further includes breaking down the plurality of topics associated with each lookalike into a plurality of categories for further reaching audiences.

In yet another aspect, the content data includes data about customers who have converted. The conversion journey is a journey of topics that a consumer follows and pays.

In another embodiment, a content marketing system includes a content development engine configured to search media content for a plurality of topics and to identify relevant topics from the plurality of topics based on a campaign, a programmatic content placement platform configured to match the plurality of relevant topics to a plurality of jobs, a predictive model engine configured to generate a predictive model for a conversion path, a contextual network configured to allow placement of jobs, and an analytic engine configured to acquire data from the content development engine, the programmatic content placement platform, the predictive mode, and the contextual network, and to optimize the conversion journey based on the acquired data.

In an aspect, the relevant topics are the most relevant topics to the campaign. The content development engine provides data for optimizing relevant topics.

In another aspect, the programmatic content placement platform provides data for targeting the plurality of relevant topics. The predictive model provides data for content conversion topics.

In still another aspect, the programmatic content placement platform identifies a publisher, on which a job is placed, based on contextual matching. The programmatic content placement platform generates data for targeting topics. The content development engine search keywords, white papers, and web content to identify the plurality of relevant topics.

In still another aspect, the programmatic content buying platform determines most relevant topics from the plurality of relevant topics. The programmatic content buying platform further identifies trending topics to determine the most relevant topics.

In still another aspect, the analytic engine analyzes content of a plurality of clients in the contextual network. The analytic engine contextually matches a group of clients to the plurality of relevant topics. The analytic engine determines whether the group of clients are optimally related to the jobs. The plurality of clients include an advertiser and an agency.

In yet another aspect, the plurality of jobs include advertisements. The conversion journey is based on the content journey to conversion.

In yet another embodiment, a method for a content marketing includes analyzing content data to determine monetizable topics, performing programmatic advertisement placement to contextually match advertisements to web content based on the monetizable topics, collecting customer data from publishers of the web content, determining conversion journeys based on the programmatic data and customer data, and determining lookalike customers based on conversion journeys.

### BRIEF DESCRIPTION OF THE DRAWINGS

FIG. 1 is a graphical diagram illustrating a configuration of a content-centric digital acquisition system according to embodiments of the present disclosure;

FIG. 2A is a graphical diagram illustrating an example of trending topic planning, programmatic trending topic buying and placement according to embodiments of the present disclosure;

FIG. 2B is a graphical diagram illustrating a predictive model according to embodiments of the present disclosure;

FIG. 3A is a block diagram of a marketing system according to embodiments of the present disclosure;

FIG. 3B is a functional block diagram of the content-centric digital acquisition system of FIG. 1 according to embodiments of the present disclosure;

FIG. 4 is a user interface illustrating an example of predicted campaign results for goals chosen by a user according to embodiments of the present disclosure;

FIG. 5 is a user interface for managing campaigns according to embodiments of the present disclosure;

FIG. 6 is a flow chart of a method for controlling content-centric marketing according to embodiments of the present disclosure; and

FIG. 7 is a flow chart of a method for determining lookalike customers according to an embodiment of the present disclosure.

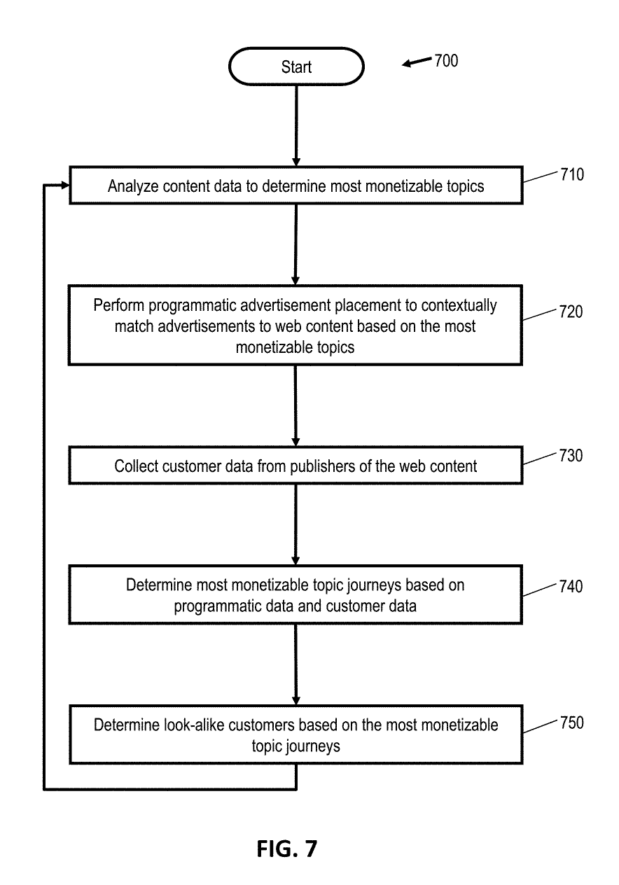

### DETAILED DESCRIPTION

Unlike existing marketing systems, the content-centric digital acquisition system of this disclosure fully incorporates the following features: (1) scalable and quality reach of authenticated, topic-engaged audiences; (2) real-time, semantic processing of web content for true contextual topic-based advertisement placement; and (3) a campaign platform that integrates data, buying, and a predictive model. Thus, by doing so, the present disclosure may identify good content journeys for prospects. In other words, the present disclosure may provide which topics in what combination leads to client's marketing goals and which existing content correlates to those topics. Further, the present disclosure may identify ways to target similar people to those who have reached the client's marketing goal.

As an initial matter, terms used in the present disclosure are defined as follows. In a case when the terms are not defined herein, terms should be interpreted or defined in a way that persons skilled in the art would do. Further, when terms are defined in this disclosure, terms are not meant to be specifically defined as set forth below but should be interpreted as examples.

As used in this disclosure, “clients” refer to the companies that purchase and install the system disclosed below. There may be two types of clients: (1) advertisers, who manage their own campaigns, and (2) agencies, who manage campaigns for multiple advertisers. “Users” refer to the people who work for the clients that operate the system. “Prospects” refer to the people who are targeted by the clients to buy from the clients. For business-to-business (B2B) clients, “prospect companies” refer to the companies that the prospects work for, who are the actual customers of the clients. “Administrators” refer to the people who manage and maintain the system and manage the deployment and configuration of users. Business-to-consumer (B2C) companies may work directly with prospects because the prospects are individual customers and consideration may be given to purchases by their spouses or other teams because they may buy units similar to prospect companies.

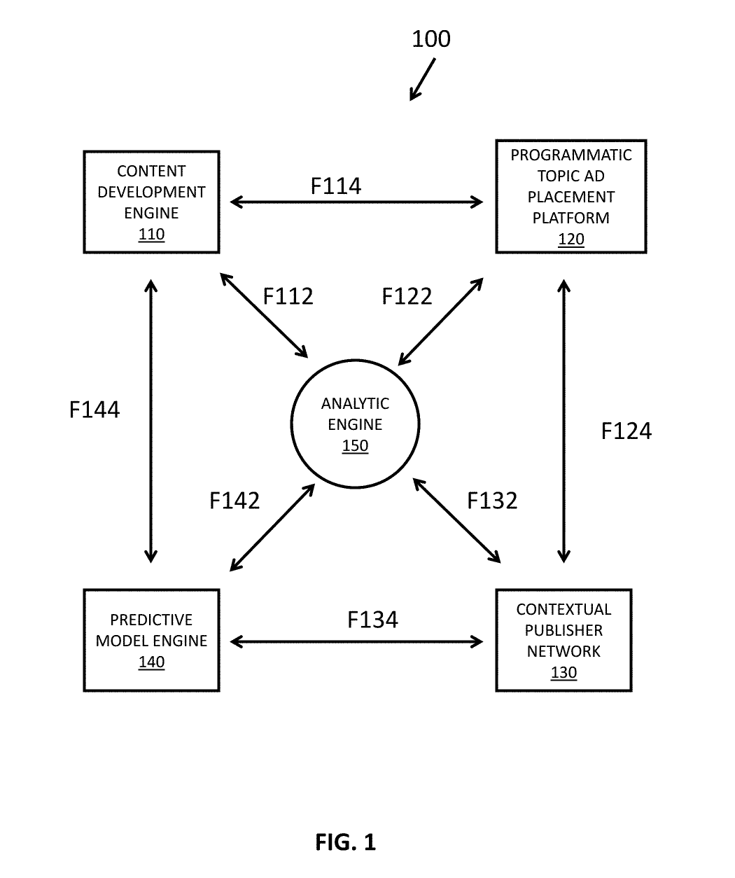

FIG. 1 illustrates a content-centric digital acquisition system 100 according to an embodiment of this disclosure. The content-centric digital acquisition system 100 integrates different types of data, performs analyses on the data, and generates a predictive model including conversion journeys. The content-centric digital acquisition system 100 includes a content development engine 110, a programmatic content placement platform 120, a contextual publisher network 130, a predictive model engine 140, and an analytic engine 150. Various data is communicated and used within the content-centric digital acquisition system 100.

Used in the content-centric digital acquisition system 100 are different types of data including one or more of system audience data, programmatic data management platform (DMP) audience data, web analytics data, site search data, marketing automation data, customer data, sales data, and web content. This list is not meant to be exhaustive but provides example. Additional or supplemental data may be used by the content-centric digital acquisition system 100.

The system audience data may be collected by the content-centric digital acquisition system 100 and include, for example, topics that a prospect has been exposed to, the prospect's location, age, gender, income level, and information regarding the prospect.

The programmatic DMP audience data may be collected from a client's DMP, such as BlueKai®, and include topics, which may be different from the topics in the system audience data, and other prospect data similar to the system audience data except that it is collected through cookie aggregation from different sources, such as Demand-Side Platforms (DSPs) rather than the source of the content-centric digital acquisition system 100.

The web analytics data may be collected from the client's web analytics system, such as Google Analytics, WebTrends®, or other data providers. This data may include sources of prospect traffic at a website, pages viewed by the prospects in the website, and conversions by the prospects or other goals attained on client assets (e.g., websites).

The site search data may be collected from site search data providers, such as SoloSegment, and include keywords searched for by prospects and content found successfully by prospects, from which topics can be mined. The site search data may provide which links in the website appear on the search results page for each keyword and in what order. Furthermore, links successfully clicked by prospects and links frustrating the prospects may be provided in the site search data.

The marketing automation data may be collected from marketing automation systems (e.g., Eloqua® or Marketo®), which personalize web contents on website. This data may include campaign execution and outcome data.

The customer data may be collected from clients. The content-centric digital acquisition system 100 may analyze the client's content (e.g., email, web pages, advertisements, and other content) based on the client's chosen goal, which is usually some definition of a marketing qualified lead (MQL). The content-centric digital acquisition system 100 may provide client users with an estimate of the expected outcome with respect to the client's chosen goal. Some of the possible goals may be email capture (e.g., prospects provide an email address to a gated content page), sharing content (e.g., prospects use white sharing, which is a button on the client's page), listening to a podcast, registration, chatbot engagement, chat representative, call me now, and anything other than the button on the client's page. The client gives the content-centric digital acquisition system 100 access to their internal systems (such as web analytics and customer relationship management (CRM)) so that the content-centric digital acquisition system 100 can access outcomes of the goal associated with the identified content.

The sales data may be collected from a CRM system, such as Salesforce or SugarCRM. This data may include the client's average close rate of a lead passed to the CRM system and the average prospect's order value.

The Web content may be collected by web spiders of the content-centric digital acquisition system 100 and subjected to contextual analysis. This data may include the content on the client's website, the websites where advertising is displayed, and the client's competitor's websites. The data may be analyzed to determine topics on the client's website, in the client's industry, and on the rest of the web.

As described above, different types of data come from many sources, starting with the programmatic data where a prospect is served an impression, clicks, goes to a website, and buys the product. Cookie aggregation techniques allow collection of dozens of fields for each prospect, with varying degrees of accuracy. Even though the data may not be accurate, it is directionally accurate enough to base predictions.

With enough topic and cookie data about enough prospects, the content-centric digital acquisition system 100 may take those who converted and look at their cookies to acquire information about what sites they have visited often. Lookalike prospects may be used to target a bigger audience than the original prospects. The content-centric digital acquisition system 100 of this disclosure uses similarities in prospect topic interests as its way of determining lookalikes.

Information from different sources is used for the lookalike determination. The content-centric digital acquisition system 100 may use an artificial intelligence (AI) to automatically cluster lookalike groups and the AI learns to be more effective through learning previous outcome data and outcome date to be come.

The content-centric digital acquisition system 100 also uses a JavaScript tag to assess traffic to a client website and to track prospect conversions with topics on and off the site that prospects viewed. The topics are derived from a list of the recent pages viewed by the prospect. Those pages are crawled and keywords are extracted to be ranked by their similarity to the essence of the topic of that page. The keywords are clustered into topics for keywords that stick together so that each prospect has a few clusters.

Referring back to FIG. 1, when a client determines acquisition goals, keywords, and topics to be advertised, the content development engine 110, which forms a contextual data layer of the content-centric digital acquisition system 100, receives the acquisition goals, keywords, and topics, and identifies the most monetizable topics. The content development engine 110 extracts or identifies data by a topic discovery tool thereof and identifies a group of topics.

In particular, through a communication channel F112, the content development engine 110 transmits the group of topics to the analytic engine 150, which optimizes it and generates the most monetizable topics. During the optimization, the analytic engine 150 may execute media buys based on the optimized topics to see which topics works. Further, the analytic engine 150 may rework a campaign to buy again to further refine the optimized topics. The analytic engine 150 then transmits the identified/refined topics, as the most monetizable topics, back to the content development engine 110 through the communication channel F112.

For example, a client has 10,000 keywords and 100 topics, and wants to buy advertisements by using those keywords and topics for PPC marketing. Upon receiving the keywords and topics, the content development engine 110 analyzes the 10,000 keywords and 100 topics and suggests the most monetizable topics therefrom, which may be interesting and/or valuable to the client.

In an aspect, the content development engine 110 may buy an advertisement for the keywords and topics so that new keywords and topics for conversion may be further identified. Such new keywords and topics may be included in the most monetizable topics.

Through a communication channel F114, the content development engine 110 may receive a data discovery tool from the programmatic topic ad placement platform 120 and the data discovery tool may aid the content development engine 110 or the client to identify the most monetizable topics. After the most monetizable topics are identified, the client determines topics therefrom and decides to run advertisements. Through the communication channel F114, the content development engine 110 transmits the topics and advertisements determined by the client to the programmatic topic ad placement platform 120, which contextually matches relevant web contents to the topics and advertisements. the programmatic topic ad placement platform 120 communicates through a communication channel F122 with the analytic engine 150 to enhance targeting the topics.

The programmatic topic ad placement platform 120 may further provide a programmatic platform for the client, through which advertisements responses are received and topic data is gathered. In an aspect, blockchain technology may be employed in the programmatic topic ad placement platform 120 to verify real time intent audience segments by using a distributed ledger system, which provides transactions with clarity and data trackability with certainty. Thus, with these characteristics of the blockchain technology, advertisers can buy universally trusted audience segments based on topics that the advertisers can verify.

The contextual publisher network 130 may allow for accurate topic-based ad placement and rich intent data, which is generated after advertisements have been placed on the contextual publisher network 130. The rich intent data is provided to the analytic engine 150 for topic optimization through a communication channel F132 and also provided to the predictive model engine 140 in real time through a communication channel F134.

Further, the contextual publisher network 130 may cooperate with the programmatic topic ad placement platform 120 to give and receive feedback for optimum topic engagement via a communication channel F124. In this regard, the analytic engine 150 provides optimized data to the contextual publisher network 130 through the communication channel F132.

In an aspect, the content-centric digital acquisition system 100 may run its own advertisement exchange. As each page comes up for bid for the advertisements, the analytic engine 150 or the programmatic topic ad placement platform 120 analyzes which topics are on the page to decide whether and how much to bid for each client.

In another aspect, some of the early campaigns for the client may be to acquire data not about an individual prospect but about cohorts of prospects. The content-centric digital acquisition system 100 may be active in buying programmatic media on behalf of some clients to acquire the data about cohorts of prospects so that the clients believe the content-centric digital acquisition system 100 is a good customer of the advertisement exchanges. In this way, data can be tracked for a significant number of prospects and more data can be collected to fuel lookalike analyses.

The predictive model engine 140 may analyze the intent received through the communication channel F134 from the contextual publisher network 130 and identify content journey to conversion while cooperating with the analytic engine 150 through a communication channel F142. Based on the content journey to conversion, the predictive model engine 140 may generate a predictive model for conversion. When the client receives the predictive model, the client then starts new advertisement campaigns with the predictive model. In this way, the client experiences better acquisition results.

The predictive model engine 140 may further provide the content journey to conversion as a feedback to the content development engine 110 through a communication channel F144.

In an aspect, the predictive model may need an access to the stored data described above. To handle business-to-business (B2B) clients, the content-centric digital acquisition system 100 may construct a data architecture that stores prospect data, identifies the prospect's company, and/or even identifies cohorts of prospects working within the same company or working on the same purchase of client products.

The predictive model may cluster prospects into similar groups, e.g., lookalikes. The lookalikes may share common characteristics, such as gender, interest, hobbies, skills, health conditions, financial conditions, jobs, or age, and may share common goal characteristics (such as high email capture). These lookalike targets allow the campaign to place advertisements to large groups of prospects on which the content-centric digital acquisition system 100 has no existing data. It is also possible to cluster prospects based on their prospect companies' similarities (such as North American Industry Classification System (NAICS) codes to determine industry or company size), and may even benefit from clustering prospect companies, if there is enough data. This clustering allows the content-centric digital acquisition system 100 to target groups that are more likely to achieve the campaign's goal.

After developing the clusters, the content-centric digital acquisition system 100 may identify the topics (possibly in some rough order) that the more successful clusters (those most likely to reach the client's goal) tend to be exposed to. That provides the content-centric digital acquisition system with the information as to which topics should be targeted in the campaigns. The content-centric digital acquisition system 100 may employ the successful prospects with their topics to train the predictive model for that client to determine which characteristics of those prospects are most likely to predict successful future prospects. This topic analysis goes beyond simple lookalike analysis to employ topics to find similar prospects that would not normally appear to be lookalikes.

The topics associated with each user may be broken down into one or more of the following types of topics for training the predictive model:
Searched topics which the prospect searched for in web search engines or on the client's site search;
Organic topics which the prospect found through searching or navigation;
Targeted topics which is presented to the prospect through advertising;
Client topics which the prospect found on the client's site; and
Related topics which the predictive model may suggest and the client may accept or reject as part of the campaign, in cases where there is not enough advertisement inventory to utilize the budget with any of the above topics.

These types of topics may be expanded by categorizing topics to see if weighting the ways prospects are exposed to topics improves the prediction ability of the predictive model.

Similarly, the content-centric digital acquisition system 100 may preserve the order of the topics in the content journey to conversion, because some modeling techniques perform better with sequences in data (e.g., Recurrent Neural Networks (RNNs)).

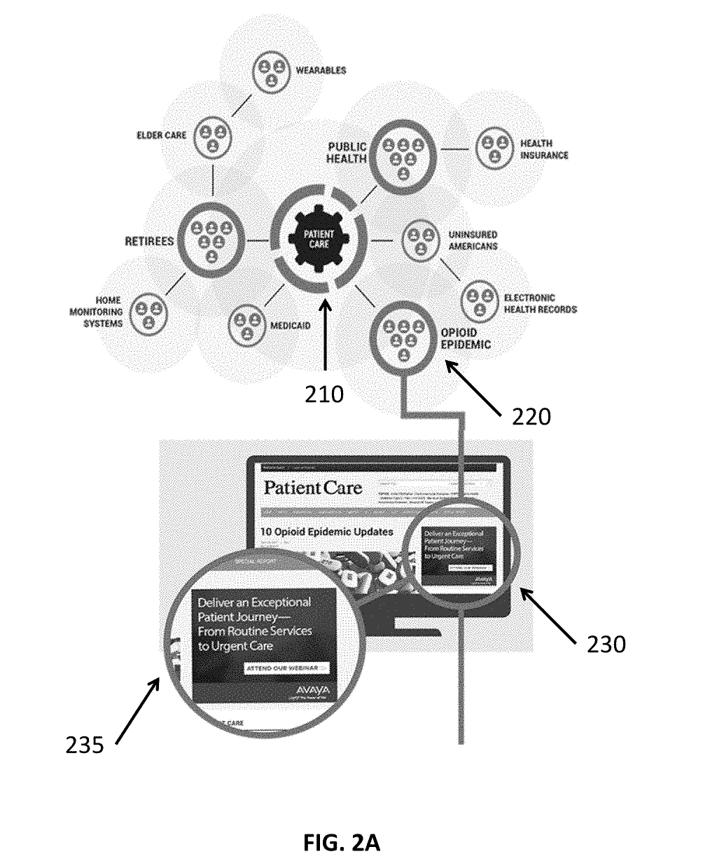

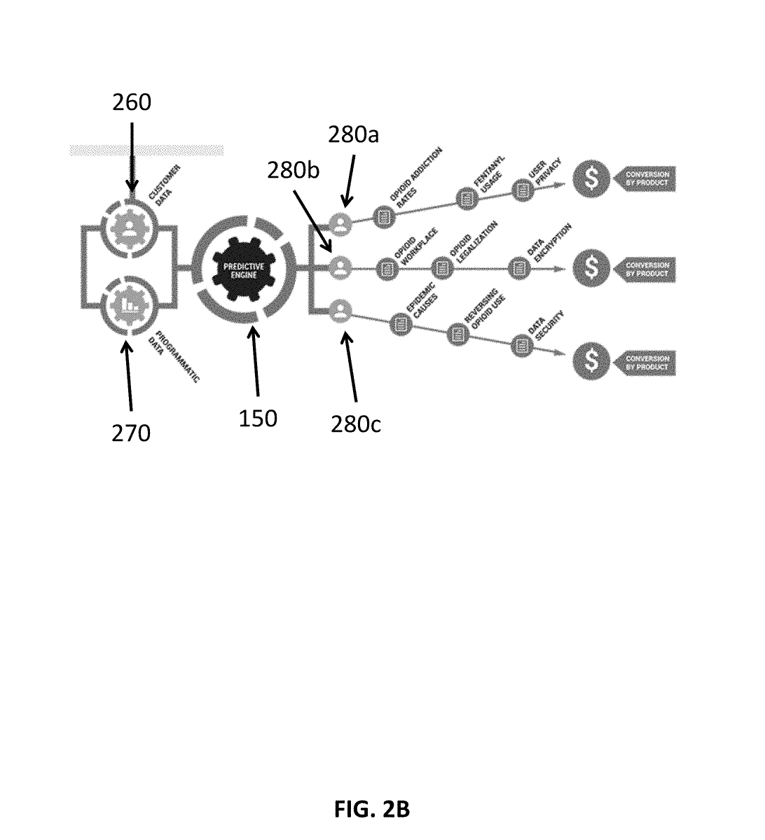

FIGS. 2A and 2B illustrate an example of trending topic planning, programmatic trending topic buying, and a predictive model of the content-centric digital acquisition system of FIG. 1. For example, when a client has keywords and topics 210 related to patient care, the content development engine 110 analyzes the keywords and topics 210 provided by the client and identifies a group of related topics, such as public health, which leads to health insurance, uninsured Americans, which leads to electronic health records, Medicaid, retirees which leads to home monitoring systems and elder care, which leads to wearables, and opioid epidemic 220. The content development engine 110 further identifies and suggests the most relevant or monetizable topics, such as opioid epidemic 220, that should be pursued in paid campaigns to attract the right visitors to the client's site.

The analytic engine 150 understands and analyzes content displayed in websites, and determines which website displays topics related to the most monetizable topic, such as opioid epidemic 220. The programmatic topic ad placement platform 120 purchases displayed media on content sites 230 whose topics align with the most monetizable topics for the client. For example, the content sites 230 includes information regarding patient care, which has “10 Opioid Epidemic Updates.” Thus, the client's advertisement of “Deliver an Exceptional Patient Journey—From Routine Services to Urgent Care” 235, which related to the opioid epidemic, is displayed over the website 230 displaying content titled “10 Opioid Epidemic Updates.” In an aspect, the client's users may utilize a dashboard user interface that demonstrates the success of each campaign.

The predictive model engine 140 may merge the customer data 260 and programmatic data 270 to generate a predictive model illustrating a customer's content path or journey to conversion. As shown in FIG. 2B, based on the generated predictive model with the most relevant or monetizable topics, the following three content journeys to conversion are identified. According to the first content journey 280a, opioid addiction rates, which leads to fentanyl usage, which leads to user privacy, which leads a user to purchase a product. According to the second content journey 280b, opioid workplace, which leads to opioid legalization, which leads to data encryption, which leads the user to purchase a product. According to the third content journey 280c, epidemic causes, which leads to reversing opioid use, which leads to data security, which leads the user to purchase a product. All these content journeys 280a-280c are conversion journeys by product. In this way, relevant audiences who gather around trending topics as they emerge are identified and expanded.

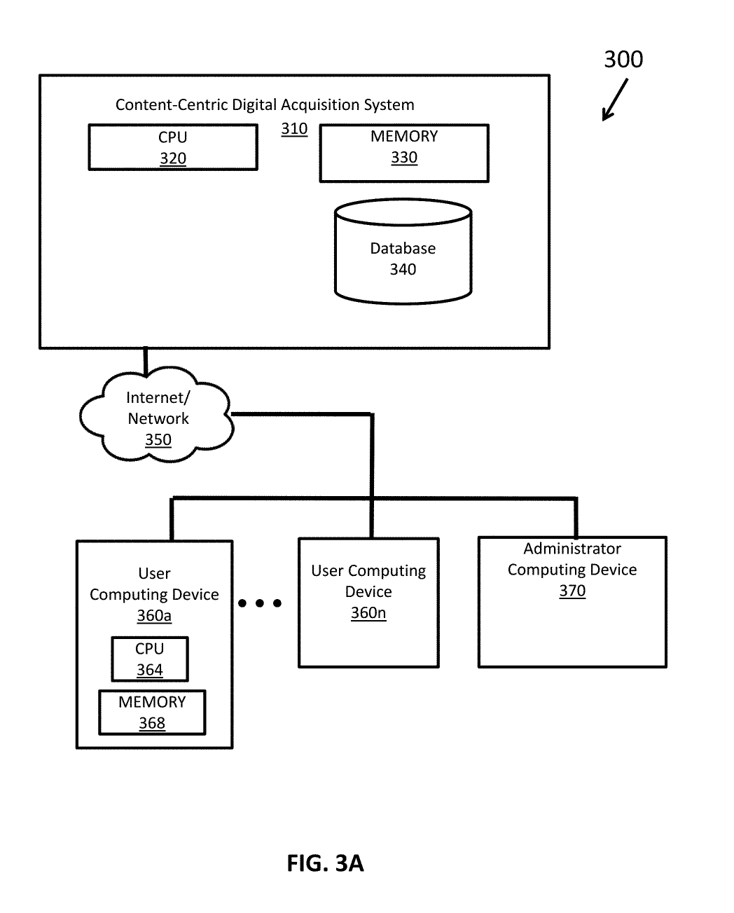

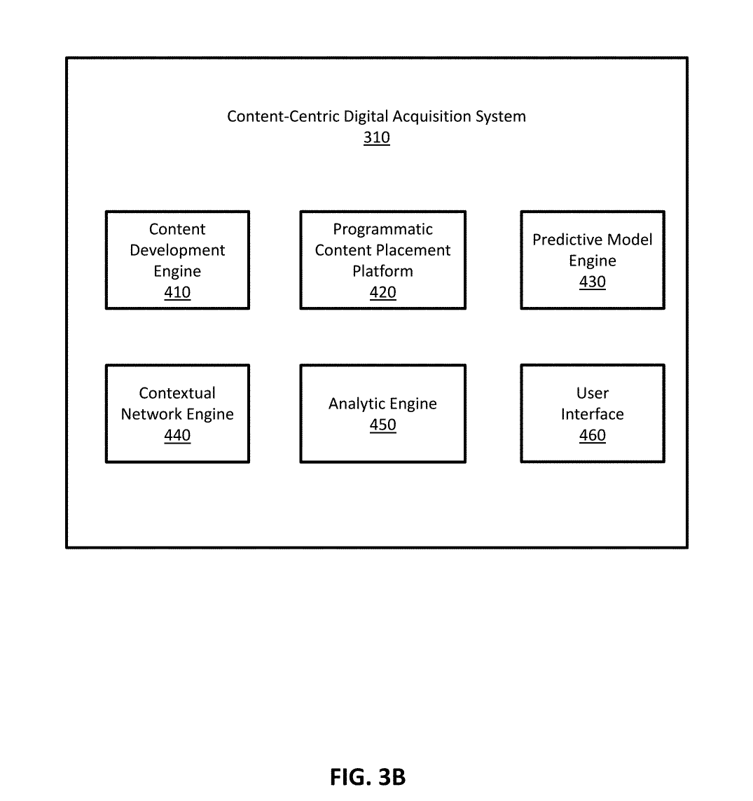

FIG. 3A is a block diagram illustrating marketing industry 300 including a content-centric digital acquisition system 310. In the marketing industry 300, there are two kinds of clients: an advertiser and a publisher. The marketing industry 300 may further include an administrator who manage marketing, ad buying, or providing any predictive model for clients. The clients may have one of computing devices 360a-360n so that the content-centric digital acquisition system 310 may acquire through the network 350 data from the clients. The administrator may have a computing device 370 specifically designed to perform administrative tasks. The computing device 370 for the administrator may generally be faster, more secured, and more reliable than the user computing devices 360a-360n. the computing device 370 may communicate through the network 350 with the content-centric digital acquisition system 310. The network 350 may be the Internet, local or wide area network, wired or wireless network. In an aspect, the network 350 may be any communication means among the content-centric acquisition system 310, the user computing devices 360a-360n, and the administrator computing device 370.

The computing devices 360a-360n and 370 may include a memory 368 and a central processing unit (CPU) 364. Likewise, the content-centric digital acquisition system 310 may include a memory 330 and a CPU 320. The memory 330 of the content-centric digital acquisition system 310 may include a database 340 storing various kinds of data including customer data, audience data, programmatic DMP audience data, web analytics data, site search data, marketing automation data, sales data, and web content. The CPU 320 and the memory 330 of the content-centric digital acquisition system 310 may cooperate with each other to perform various functions as described above with respect to the content-centric digital acquisition system 100 of FIG. 1.

The memory 330 or 368 may include any non-transitory computer-readable storage media for storing data and/or software that is executable by the CPU 320 or 364, respectively, and which controls the operation of the content-centric digital acquisition system 300 or the computing devices 360a-360n or 370. In an aspect, the memory 330 or 368 may include one or more solid-state storage devices such as flash memory chips. Alternatively or in addition to the one or more solid-state storage devices, the memory 330 or 368 may include one or more mass storage devices connected to the CPU 320 or 364 through a mass storage controller (not shown) and a communications bus (not shown). Although the description of computer-readable media contained herein refers to a solid-state storage, it should be appreciated by those skilled in the art that computer-readable storage media can be any available media that can be accessed by the CPU. That is, computer readable storage media includes non-transitory, volatile and non-volatile, removable and non-removable media implemented in any method or technology for storage of information such as computer-readable instructions, data structures, program modules or other data. For example, computer-readable storage media includes RAM, ROM, EPROM, EEPROM, flash memory or other solid state memory technology, CD-ROM, DVD, Blu-Ray or other optical storage, magnetic cassettes, magnetic tape, magnetic disk storage or other magnetic storage devices, or any other medium which can be used to store the desired information.

The memory 330 or 368 may also include processor-executable instructions stored thereon, which, when executed by the CPU 320 or 364, may cause the computing device to perform all functions or tasks described with reference to the content-centric digital acquisition system 300, the user computing devices 360a-360n, or the administrator computing device 370.

FIG. 3B shows a functional block diagram of the content-centric digital acquisition system 310, which includes a content development engine 410, a programmatic topic ad placement platform 420, a contextual publisher network 430, a predictive model engine 430, an analytic engine 450, and a user interface (UI) 460. Descriptions for the content development engine 410, the programmatic topic ad placement platform 420, the contextual publisher network 430, the predictive model engine 440, and the analytic engine 450 are similar to the above descriptions for the content development engine 110, the programmatic topic ad placement platform 120, the contextual publisher network 130, the predictive model engine 140, and the analytic engine 150 of FIG. 1, respectively, and thus are omitted here.

The UI 460 of the content-centric digital acquisition system 310 may provide a registration process. Once registration is complete, users are directed to add products to their account. Any user with one product can see a path to purchase other products. The content-centric digital acquisition system 310 may support all major web browsers, such as Chrome, Firefox, Safari, and Internet Explorer/Edge.

As part of the signup process, the user is shown a JavaScript tag which is placed on each page of the client's website. This can be done by directly editing the HTML to include the JavaScript tag or adding it to an existing tag manager. Once the tag is placed on the site, the content-centric digital acquisition system 310 may be able to gather data regarding which prospects are reaching the site and which topics are driving goal attainment.

In an aspect, users may have access to multiple advertiser accounts, so that when they sign in, they may be presented with an account selection screen that allows them to choose the account they wish to view. Once the account is chosen, an agency user sees the same data and has the same authority that an advertiser user would have for their own account.

The first time the user accesses the content-centric digital acquisition system 310, there may be no existing models in the content-centric digital acquisition system 310, so the user has to create a campaign page. A new dashboard may show the client user a list of client offerings (products and services). The user chooses one or more of the offerings to base the campaign along with the campaign's goal, such as impressions, clicks, unique visitors, page views, video views, shares, comments, downloads, registrations, email opt-ins, demo requests, leads acquired, customers acquired, reactivated customers, number of sales orders, average order size or value, ratings, and/or recommendations.

Once the offerings and the goals are selected, the user is shown a list of topics associated with selected offerings including one or more of the following: topics the client has created content for, topics the client's competitors have created content for, trending news topics that impact the industry, top performing topics based on data gathered from the Client's website, and top performing topics in digital media (e.g., PPC, digital advertising, and programmatic advertising).

After reviewing the list of topics, the user can choose which topics to use for the marketing campaign. The user's choice of topics may be based on which topics seem the best or which topics the client has content for.

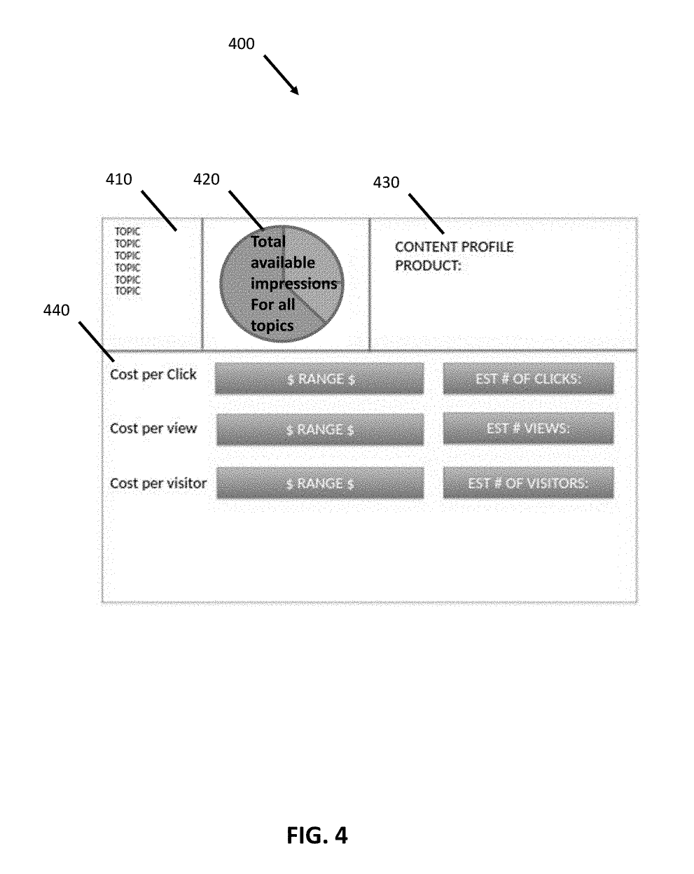

The user may choose a budget range or may allow an unlimited budget. FIG. 4 shows a user interface (UI) 400 for allocating budget ranges. The user may enter topics related to a campaign in box 410, a total number of impressions for all topics in box 420, content profile product in box 430, and costs in box 440. The user may be able to set budget ranges and estimations for cost per click, cost per view, and cost per visitor.

The total number of impressions for all topics in box 420 may allow the user to allocate percentages of each campaign in box 410. For example, one campaign may be set to 40% of the total impressions and the other campaigns may be set to 60% of the total impressions. In an aspect, the user may be able to set the corresponding allocation for each campaign by adjusting the circular graph as shown in FIG. 4 or the user may be able to enter the corresponding percentage for each campaign so that the circular graphic shows appropriate areas for the campaign in the circular graph.

In box 440, the user may set a cost budget range for one upper limit of clicks and another cost budget range for another upper limit of clicks. In other words, depending on levels of the number of clicks, the user may set different cost budget ranges. The cost per view and the cost per visitor may be set similarly as the cost per click.

In another aspect, the user may set different budget ranges depending on geographical regions where clicks or views occur, or visitors reside.

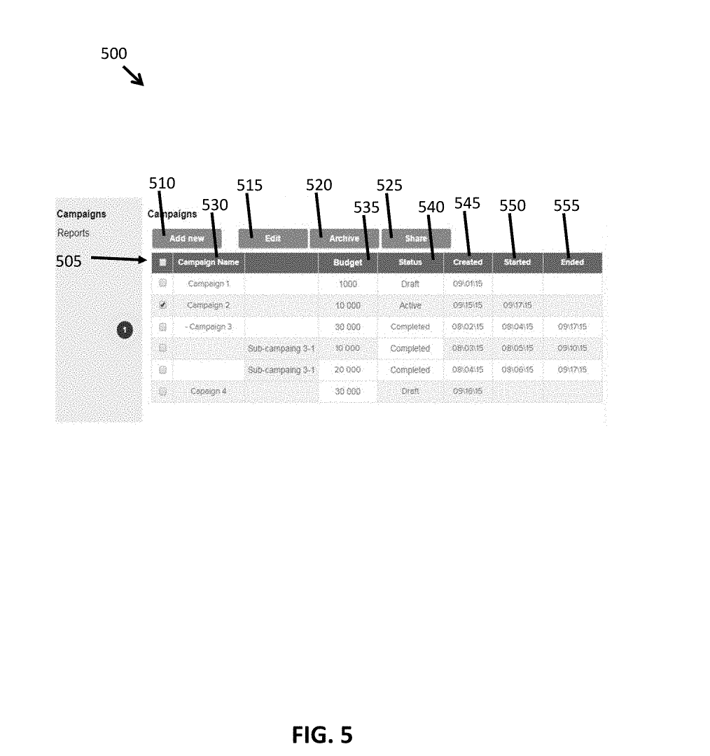

After all pieces of a new campaign have been selected and set, a dashboard user interface (UI) 500 may be displayed as shown in FIG. 5. The dashboard UI 500 may show predicted campaign results for the goal chosen by the user. A new campaign may be added by clicking button 510. An existing campaign can be edited by clicking button 515, archived by clicking button 520, and shared by clicking button 525. For each campaign, the dashboard UI 500 displays various fields including the campaign name 530, the budget 535, the status 540, the date of creation 545, the starting date 550, and the ending date 555. The dashboard UI 500 further includes a column for sub-campaigns. For example, Campaign 3 has sub-campaign 3-1 and 3-2.

The status field 540 indicates the current status of a campaign, as “Draft,” “Active,” and “Completed”.

Using the dashboard UI 500, the user may be able to examine potential results and take one or more of the following actions:
Modify parameters. The offerings, goals, topics, and/or budget may be adjusted to see the effect of new parameters on goal attainment.
Run the campaign. If the user wants to execute the campaign, the content-centric digital acquisition system may present the details of the campaign to the user and request final campaign approval from the user.
Save the campaign. The user may store the campaign to be cloned or to be modified later. The user is prompted to give the campaign a name before it is stored.
   For campaigns which have already been executed or currently running campaigns, the dashboard UI 500 may show recent performance data from those campaigns.

In an aspect, the user may sort the campaigns by any field by clicking the appropriate field in the header 505. Clicking once sorts the campaigns according to the selected field in the ascending order and clicking again sorts the campaigns according to the selected field in the descending order. The default for sorting is to show the same order as the last time the user signed into the content marketing system. If this is the first time the content-centric digital acquisition system is being used by a user, the default for sorting may be to show the most recently modified campaigns first.

In another aspect, the user may be able to filter campaigns based on the values in the fields. This may be shown as a faceted search or as a left-hand navigation bar. In addition to the fields shown in FIG. 5, the facets may include whether the campaign is active or archived. The default for filtering may be to show the same filters as the last time the user signed into the content marketing system, or to show all campaigns as if this is the first time signing in.

Each row in the list contains a campaign and also has a drop-down action menu that the user can employ to perform one or more of the following actions on campaigns:
Edit the campaign. The user may select “Edit” from the drop-down action menu or can double click on any part of the row containing a campaign to select it and edit it. This causes the system to display the campaign in the screen which allows the user to work with the campaign. Further, the user may select one or more campaigns and click the Edit button 515 to edit values of each field.
Clone the campaign. The user can select “Clone” from the drop-down action menu, in which case a new model called “Copy of” the original campaign's name is shown in the list under the original campaign.
Rename the campaign. The user can select “Rename” from the drop-down action menu, in which case the campaign name field becomes editable. This can be done by selecting the campaign and clicking the Edit button 515. Also, by double clicking the campaign name to select the campaign name and typing a new name, the campaign name can be renamed.
Archive an active campaign. The user can select one or more campaigns by clicking the checkboxes next to the campaign name field and press the archive button 520, in which case the row for each selected campaign is turned gray, indicating the archived state.
Activate an archived campaign. The user can select one or more campaigns by clicking the checkboxes next to the campaign name field and press the archive button 520, in which case the campaign is turned black, indicating the activated state. In an aspect, the archive button 520 is a toggle switch between archiving and activating.
Compare campaigns. The user can select two or more campaigns by clicking the checkboxes next to the campaign name field and press a compare button, in which case only those campaigns will be shown in the list. The compare button then changes to show all, which the user can press to show all the campaigns.

Regarding Campaign 1 as shown in FIG. 5, its budget has been allocated 1000. The campaign was created on Sep. 1, 2015. Based on its status “Draft,” the campaign is in a process of drafting, but is not completed yet.

Regarding Campaign 2, its budget has been allocated 10000. Since Campaign 2 has been started since Sep. 17, 2015, the status is “Active” but the ended date is left blank.

When the status is “Complete,” the ended date is filled as, for example, 9/17/15 for Campaign 3 and sub-campaign 3-1. In cases when two sub campaigns are ended at different dates, the ended date for the main campaign is the last date of the completions. For example, the sub-campaign 3-1 was ended on Sep. 10, 2015 and the sub-campaign 3-2 was ended on Sep. 17, 2015. The ended date for the main campaign, Campaign 3, is considered as being ended on Sep. 17, 2015, as shown in FIG. 5.

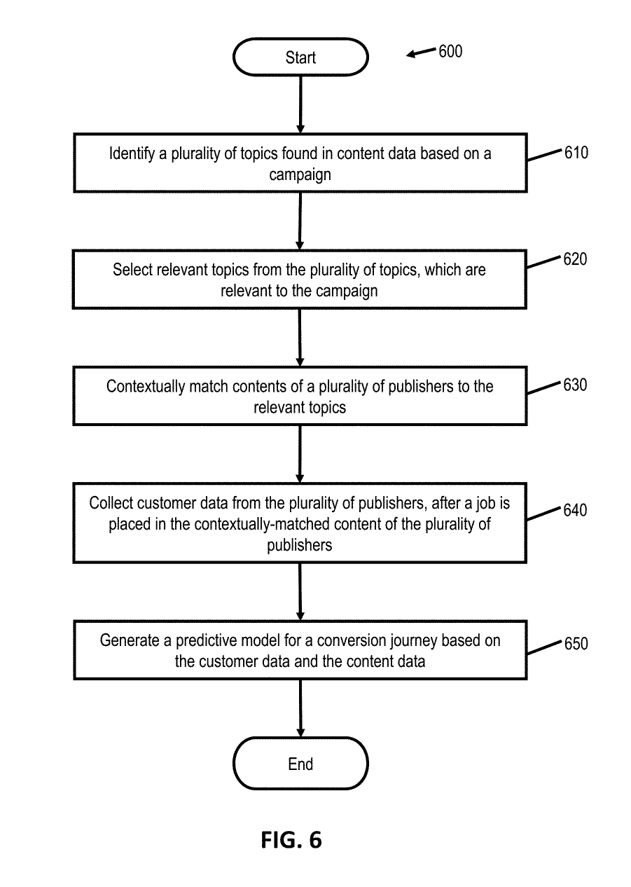

Now referring to FIG. 6, illustrated is a method 600 for controlling content-centric marketing according to embodiments of the present disclosure. The method 600 focuses on the intersection of direct marketing, content marketing, and digital media marketing to predict the most monetizable trending topic. The method 600 starts with step 610, in which a plurality of topics found in content data based on a campaign are identified. When a customer starts a campaign, the customer provides a plurality of topics and content data. An analytic engine of the content-centric marketing system analyzes the content data and outputs a plurality of topics, which are relevant to the campaign.

In step 620, the customer selects relevant topics from the plurality of topics. The content-centric marketing system, then, contextually selects a plurality of publishers based on the selected topics in step 630.

The plurality of publishers publish the selected topics on websites, whose contents are contextually matched with the selected topics. In step 640, customer responses to the published topics are collected from the plurality of publishers. Such responses may include emails, phone numbers, addresses, IP addresses, opt-ins to email marketing, surveys, reviews, website addresses where the customers click links, etc. This list is not meant to be limiting but may be extended to other related information, which can be readily appreciated by persons having skill in the art.

In step 650, the content-centric marketing system generates a predictive model for a conversion journey based on the customer data and the content data. This conversion journey identifies a chain of topics through which customers pay for or buy products.

FIG. 8 shows a flowchart illustrating a method 800 for determining lookalike customers according to embodiments of the present disclosure. When client provides keywords and/or topics to find out conversion journeys, the method 800 starts by analyzing content data to determine the most monetizable topics at step 810 by the content development engine. The most monetizable topics may be refined by the acquisition analytics engine. Further, among the determined or refined most monetizable topics, the client may choose topics to further refine the topics.

The programmatic content placement platform performs programmatic advertisement placement to contextually match advertisements to web content based on the most monetizable topics at step 820. After placing the advertisements to the contextually matched web content by the publishers, the content-centric digital acquisition system collects customer data from publishers of the web content at step 830.

The predictive model engine determines the most monetizable topic journeys based on programmatic data and customer data at step 840. Then, at step 850, look-alike customers are determined based on the most monetizable topic journeys.

In an aspect, after step 850, the method 800 may be back to step 810 to further refine optimization processing for determining lookalike customers. In an aspect, the method 800 may train AI based on previous customer data and previous programmatic data

Detailed embodiments of devices, systems incorporating such devices, and methods using the same have been described herein. However, these detailed embodiments are merely examples of the disclosure, which may be embodied in various forms. Therefore, specific structural and functional details disclosed herein are not to be interpreted as limiting, but merely as a basis for the claims and as a representative basis for allowing one skilled in the art to variously employ the present disclosure in virtually any appropriately detailed structure. While the preceding embodiments have been described in terms of content-centric marketing, those skilled in the art will realize that the same or similar devices, systems, and methods may be used in digital marketing, direct marketing, and/or social media marketing.

What is claimed is:

1. A method for a content marketing, the method comprising:
identifying a plurality of topics found in content data based on a campaign;
selecting relevant topics from the plurality of topics, which are relevant to the campaign;
contextually matching contents of a plurality of publishers to the relevant topics;
collecting customer data from the plurality of publishers, after a job is placed in the contextually-matched content of the plurality of publishers; and
generating a predictive model for a conversion journey based on the customer data and the content data.

2. The method according to claim 1, wherein the predictive model reflects a customer's content journey to conversion.

3. The method according to claim 1, wherein the most relevant topics are trending topics.

4. The method according to claim 1, wherein the content data includes first customer data from an external source and second content data from a client.

5. The method according to claim 4, wherein the first customer data has been aggregated from websites via cookies or javascripts.

6. The method according to claim 4, wherein the topics are identified from the second content data.

7. The method according to claim 4, wherein the content data further includes third customer data for potential customers.

8. The method according to claim 4, wherein identifying the plurality of topics includes:
clustering the first customer data to obtain a plurality of lookalikes; and
identifying the plurality of topics based on a level of success in the plurality of lookalikes.

9. The method according to claim 8, wherein the job is related to the identified topics.

10. The method according to claim 8, wherein the plurality of publishers are contextually matched to the identified topics in real time.

11. The method according to claim 8, wherein identifying the plurality of topics further includes breaking down the plurality of topics associated with each lookalike into a plurality of categories for further reaching audiences.

12. The method according to claim 1, wherein the content data includes data about customers who have converted.

13. The method according to claim 1, wherein the conversion journey is a journey of topics that a consumer follows and pays.

14. A content marketing system comprising:
a content development engine configured to search media content for a plurality of topics and to identify relevant topics from the plurality of topics based on a campaign;
a programmatic content placement platform configured to match the plurality of relevant topics to a plurality of jobs;
a predictive model engine configured to generate a predictive model for a conversion path;
a contextual network configured to allow placement of jobs; and
an analytic engine configured to acquire data from the content development engine, the programmatic content placement platform, the predictive mode, and the contextual network, and to optimize the conversion journey based on the acquired data.

15. The content marketing system of claim 14, wherein the relevant topics are the most relevant topics to the campaign.

16. The content marketing system of claim 14, wherein the content development engine provides data for optimizing relevant topics

17. The content market system of claim 14, wherein the programmatic content placement platform provides data for targeting the plurality of relevant topics.

18. The content market system of claim 14, wherein the predictive model provides data for content conversion topics.

19. The content market system of claim 14, wherein the programmatic content placement platform identifies a publisher, on which a job is placed, based on contextual matching.

20. The content market system of claim 19, wherein the programmatic content placement platform generates data for targeting topics.

21. The content marketing system of claim 14, wherein the content development engine search keywords, white papers, and web content to identify the plurality of relevant topics.

22. The content marketing system of claim 14, wherein the programmatic content buying platform determines most relevant topics from the plurality of relevant topics.

23. The content marketing system of claim 22, wherein the programmatic content buying platform further identifies trending topics to determine the most relevant topics.

24. The content marketing system of claim 14, wherein the analytic engine analyzes content of a plurality of clients in the contextual network.

25. The content marketing system of claim 24, wherein the analytic engine contextually matches a group of clients to the plurality of relevant topics.

26. The content marketing system of claim 25, wherein the analytic engine determines whether the group of clients are optimally related to the jobs.

27. The content marketing system of claim 24, wherein the plurality of clients include an advertiser and an agency.

28. The content marketing system of claim 14, wherein the plurality of jobs include advertisements.

29. The content marketing system of claim 14, wherein the conversion journey is based on the content journey to conversion.

30. A method for a content marketing, the method comprising:
analyzing content data to determine monetizable topics;
performing programmatic advertisement placement to contextually match advertisements to web content based on the monetizable topics;
collecting customer data from publishers of the web content;
determining conversion journeys based on the programmatic data and customer data; and
determining lookalike customers based on conversion journeys.
